(19) United States
(12) Patent Application Publication
(10) Pub. No.: US 2013/0144507 A1
(43) Pub. Date: Jun. 6, 2013

(54) LOW PRESSURE FUEL PUMP CONTROL METHOD OF GDI ENGINE

(71) Applicant: Bum Ky Lee, Suwon-si (KR)

(72) Inventor: Bum Ky Lee, Suwon-si (KR)

(73) Assignees: Kia Motors Corp., Seoul (KR); Hyundai Motor Company, Seoul (KR)

(21) Appl. No.: 13/551,203

(22) Filed: Jul. 17, 2012

(30) Foreign Application Priority Data
Dec. 1, 2011 (KR) 10-2011-0127452

(51) Int. Cl. F02D 1/02

(52) U.S. Cl. 701/103

(57) ABSTRACT

A low pressure fuel pump controlling method for a fuel feeding system of a GDI engine that includes a low pressure system and a high pressure system including controlling the low pressure fuel pump against various problems that may occur during the driving of the engine by variable control of the low pressure fuel pump of the low pressure system for the improvement of fuel efficiency of a vehicle. In various situations, the method drives the low pressure fuel pump under a relatively higher pressure than the fuel efficiency pressure.

### CROSS-REFERENCE TO RELATED APPLICATION

The present application claims priority of Korean Patent Application Number 10-2011-0127452 filed on Dec. 1, 2011, the entire contents of which application are incorporated herein for all purposes by this reference.

### BACKGROUND OF INVENTION

1. Field of Invention

The present disclosure relates to a method of controlling a low pressure fuel pump of a gasoline direct injection (GDI) engine. More particularly, it relates to technologies of overcoming drawbacks occurring during the variable control of a low pressure pump to improve fuel efficiency of a vehicle and to secure driving stability.

2. Description of Related Art

For the injection of fuel into combustion chambers by high pressure, a GDI engine includes a fuel feeding system that has a low pressure system and a high pressure system. The high pressure system additionally compresses the fuel pressed by the low pressure system primarily to inject the compressed fuel directly into the combustion chambers through injectors.

An existing low pressure system drives a low fuel pump to feed a designed maximum flow rate of fuel while maintaining a preset fuel pressure. Since the preset fuel pressure and the flow rate are determined to sufficiently cope with various situations in the high pressure system variable with the driving conditions of a vehicle, in most cases a low pressure fuel pump is excessively driven to continuously make a fuel pressure and a flow rate unnecessary at normal condition.

The excessive driving of the low pressure fuel pump is caused by driving the low pressure fuel pump excessively over the demand from the GDI fuel feeding system and leads undesired fuel consumption and inferior fuel efficiency of a vehicle.

Thus, if the low pressure system were variable-controlled to provide a fuel pressure and a flow rate suitable for a driving situation of a vehicle, energy consumed by the low pressure fuel pump is reduced and the fuel efficiency of a vehicle is improved.

FIG. 1 is a view illustrating a low pressure system of a GDI engine employing a brushless direct current (BLDC) motor as a low pressure fuel pump. In the low pressure system of a GDI engine, when an engine controller 500 provides a target fuel pressure to a pump controller 502, the pump controller 502 receives a signal from a fuel pressure sensor 506 installed to a low pressure fuel pump 504 and controls the low pressure fuel pump 504 under PID (Proportional, Integral, Derivative) control to follow the target fuel pressure.

The above-described pressure control corresponds to an amount of fuel consumed by the engine as possible as in real time and is capable of varying a flow rate so that current consumed by the low pressure fuel pump is reduced and fuel efficiency may be improved in comparison to an existing pressure control of always providing a maximum flow rate.

However, serious problems may occur when a feeding flow rate of the low pressure system is short in view of a driving situation of the high pressure system or when a preset target fuel pressure of the low pressure system is insufficient and unsuitable for sustaining a pressure substantially required by the high pressure system. Such serious troubles include misfire of an engine and engine stall.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present application has been made in an effort to solve the above-described problems associated with prior art. The present application provides a low pressure fuel pump controlling method for a fuel feeding system of a GDI engine, which includes a low pressure system and a high pressure system. The method controls the low pressure fuel pump against various problems that may occur during the driving of the engine by variable control of the low pressure fuel pump of the low pressure system to improve the fuel efficiency of a vehicle. The method is advantageous in that the fuel efficiency of a vehicle on which a GDI engine is mounted may be improved, that stability of driving the GDI engine may be secured, and that productivity of a vehicle may be eventually enhanced.

In accordance with various aspects of the present application, there is provided a method of variable-controlling a low pressure fuel pump of a low pressure system in a fuel feeding system of a GDI engine, including: driving the low pressure fuel pump at KEY ON of a vehicle when the GDI engine is stopped, and setting a target fuel pressure of the low pressure fuel pump to a relatively higher pressure than a fuel pressure concentrated on fuel efficiency within a fuel pressure range that is made by the low pressure fuel pump.

In accordance with various aspects of the present application, there is also provided a method of variable-controlling a low pressure fuel pump of a low pressure system in a fuel feeding system of a GDI engine, including: setting a target fuel pressure of the low pressure fuel pump at cranking of the GDI engine to a relatively higher pressure than a fuel pressure concentrated on fuel efficiency within a fuel pressure range that is made by the low pressure fuel pump.

In accordance with various aspects of the present application, there is also provided a method of variable-controlling a low pressure fuel pump of a low pressure system in a fuel feeding system of a GDI engine, including: driving the low pressure fuel pump continuously under a relatively higher pressure than a fuel efficiency pressure concentrated on fuel efficiency within a fuel pressure range that is made by the low pressure fuel pump, until a main relay is turned off at KEY OFF of a vehicle.

In accordance with various aspects of the present application, there is provided a method of variable-controlling a low pressure fuel pump of a low pressure system in a fuel feeding system of a GDI engine, including: driving the low pressure fuel pump for a preset time duration in a preset time interval at soaking when the GDI engine is cooling after KEY OFF of a vehicle.

In accordance with various aspects of the present application, there is provided a method of variable-controlling a low pressure fuel pump of a low pressure system in a fuel feeding system of a GDI engine, including: driving the low pressure fuel pump at a high pressure within a fuel pressure range that is made by the low pressure fuel pump in a case when at least one of situations occur, wherein the situations include malfunction of a high pressure system, an extreme high temperature traveling, an extreme low temperature traveling, an extreme high land traveling, or detection of HIGH DI fuel.

In accordance with various aspects of the present application, there is provided a method of variable-controlling a low pressure fuel pump of a low pressure system in a fuel feeding system of a GDI engine, including: driving the low pressure fuel pump under a high pressure within a fuel pressure range that is made by the low pressure fuel pump, and restricting a closed circuit generation control for improving a fuel efficiency to secure a sufficient voltage of a battery during the driving of the low pressure fuel pump under the high pressure.

In accordance with various aspects of the present application, there is provided a method of variable-controlling a low pressure fuel pump of a low pressure system in a fuel feeding system of a GDI engine, including: driving the low pressure fuel pump at a relatively higher pressure than a fuel efficiency pressure concentrated on fuel efficiency within a fuel pressure range that is made by the low pressure fuel pump for a preset time duration in a preset time interval at KEY ON of a vehicle when the GDI engine is stopped, at cranking of the GID engine, until a main relay is turned off at KEY OFF of a vehicle, and at soaking when the GDI engine is cooling after KEY OFF of the vehicle.

According to the present application, in a fuel feeding system of a GDI engine including a low pressure system and a high pressure system, the low pressure fuel pump controlling method of a GDI engine controls the low pressure fuel pump against various problems that may occur during the driving of the engine by variable control of the low pressure fuel pump of the low pressure system for the improvement of fuel efficiency of a vehicle so that the fuel efficiency of a vehicle on which a GDI engine is mounted may be improved, that stability of driving the GDI engine may be secured, and that productivity of a vehicle may be eventually enhanced.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating operations of an existing low pressure system of a GDI engine employing a BLDC motor as a low pressure fuel pump;

FIG. 2 is a graph illustrating an exemplary low pressure fuel pump controlling method of a GDI engine according to the present application;

FIG. 3 is a flow chart illustrating the exemplary low pressure fuel pump controlling method of a GDI engine at KEY-ON according to the present application;

FIG. 4 is a flow chart illustrating the exemplary low pressure fuel pump controlling method of a GDI engine at cranking according to the present application;

FIG. 5 is a flow chart illustrating the exemplary low pressure fuel pump controlling method of a GDI engine at KEY-OFF according to the present application;

FIG. 6 is a flow chart illustrating the exemplary low pressure fuel pump controlling method of a GDI engine at soaking according to the present application;

FIG. 7 is a flow chart illustrating the exemplary low pressure fuel pump controlling method of a GDI engine according to the present application in the situation when the low pressure fuel pump needs to be driven under high pressure; and

FIG. 8 is a flow chart illustrating the exemplary control method of restricting a power generation control of a vehicle while the low pressure fuel pump is driven under high pressure.

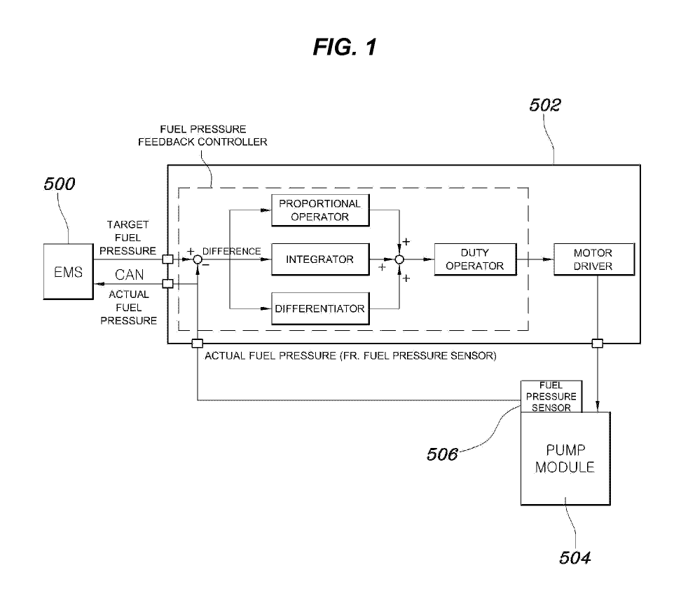

It should be understood that the appended drawings are not necessarily to scale, presenting a somewhat simplified representation of various features illustrative of the basic principles of the invention.

In the figures, reference numbers refer to the same or equivalent parts of the present application throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

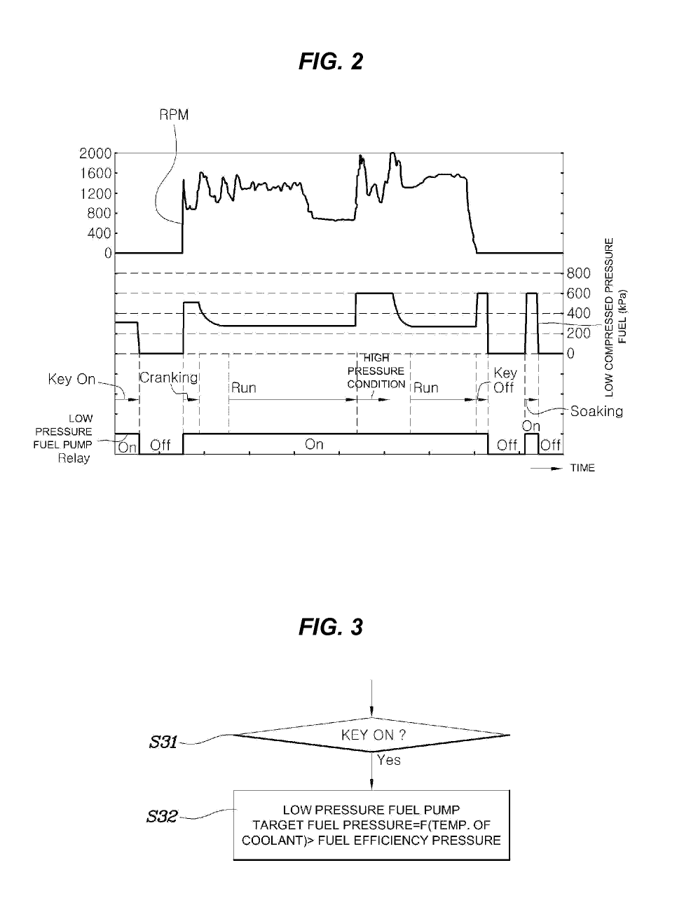

FIGS. 3 to 8 show a control method of variable-controlling a low pressure fuel pump of a low pressure system in a fuel feeding system of a GDI engine according to various embodiments of the present application suitable for situations when specific controls are required among situations occurring from a vehicle on which a GDI engine is mounted. FIG. 2 is a graph illustrating an entire control method to which all the above-mentioned situations are reflected.

Referring to FIG. 3, in a case when an engine is stopped and a key is turned on (KEY ON) (S31), a low pressure fuel pump is driven (S32) while a target fuel pressure of the low pressure fuel pump is set to a relatively higher pressure than a fuel efficiency pressure concentrated on the fuel efficiency within a fuel pressure range that is made by the low pressure fuel pump.

That is, in order to help a high pressure pump of a high pressure system, which constitutes the fuel feeding system of the GDI engine in association with the low pressure system, to form a proper fuel pressure at early starting, the low pressure fuel pump is driven at the KEY ON that is considered as a primary operation occurring before ignition of the engine such that a sufficient fuel pressure of the low pressure side can be secured.

In this case, the fuel efficiency pressure concentrated on the fuel efficiency within the fuel pressure range that is made by the low pressure fuel pump refers to a pressure set as low as possible within the range of forming the fuel pressure at the low pressure side that is required under a usual situation when an engine is driven. With such low pressure, the fuel efficiency of a vehicle may be improved. For example, if a range of the fuel pressure formed by the low pressure fuel pump is 0 bar to 6 bar, the fuel efficiency pressure is set to about 2.5 bar. In this case, the target fuel pressure of the low pressure fuel pump at the KEY ON is set to about 5 bar. In various embodiments, the relatively higher pressure within the fuel pressure range that is made by the low pressure fuel pump ranges from about 4 bar to about 6 bar.

However, since noise may occur when the low pressure fuel pump is driven by the high target fuel pressure before starting an engine as described above, the target fuel pressure of the low pressure fuel pump at the KEY ON is set according to temperature of coolant of the engine at the KEY ON. The target fuel pressure is determined relatively low as listed in Table 1 at normal temperature or at the temperature of the coolant of the engine suitable for well-driving of the engine.

TABLE 1

| | Temperature of coolant (° C.) | | | | | | | | |
|---|---|---|---|---|---|---|---|---|---|
| | −32 | −30 | −20 | −10 | 20 | 60 | 80 | 100 | 120 |
| Target fuel | 5.0 | 5.0 | 5.0 | 4.0 | 3.0 | 3.0 | 3.0 | 5.0 | 5.0 |
| pressure (bar) | | | | | | | | | |

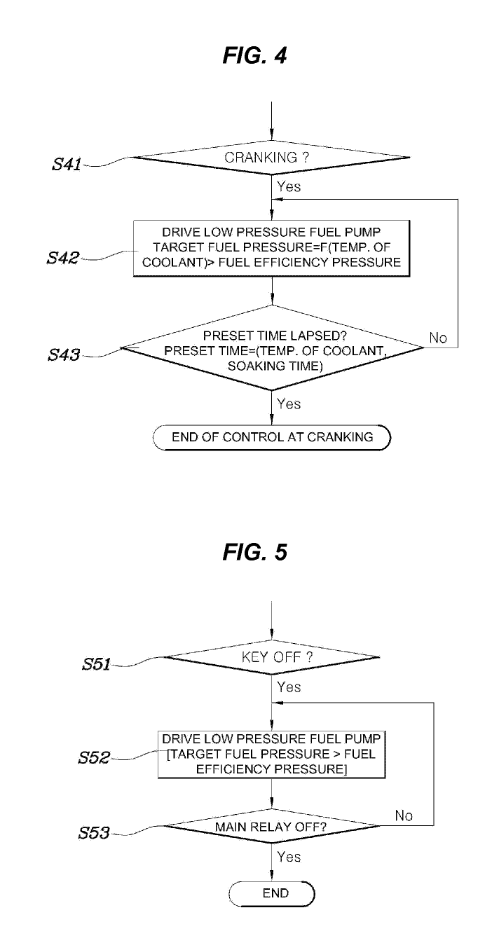

Referring to FIG. 4, in various embodiments of the present application, the target fuel pressure of the low pressure fuel pump at cranking of an engine (S41) is determined as a relatively higher pressure than the fuel efficiency pressure concentrated on the fuel efficiency within the fuel pressure range that the low pressure fuel pump makes, according to the temperature of coolant of the engine (S42).

That is, since fuel injection by sufficient high pressure at the cranking of the engine is required, the low pressure side forms a high pressure of the low pressure side at the cranking for the formation of the fuel pressure of the high pressure side.

In this case, since the required fuel pressure at the cranking is differed according to the ambient temperature of the vehicle and soaking, the target fuel pressure of the low pressure fuel pump may be determined as a function of temperature of a coolant as listed in Table 2.

TABLE 2

| | Temperature of coolant (° C.) | | | | | | | | |
|---|---|---|---|---|---|---|---|---|---|
| | −32 | −30 | −20 | −10 | 20 | 60 | 80 | 100 | 120 |
| Target fuel | 6.0 | 6.0 | 6.0 | 6.0 | 5.0 | 5.0 | 5.0 | 6.0 | 6.0 |
| pressure (bar) | | | | | | | | | |

Moreover, in a case when the cranking occurs at re-starting, to reduce or eliminate bubbles generation from a fuel line, the target fuel pressure of the low pressure fuel pump at the cranking may be continuously maintained high for a preset time duration for prevention of the bubble generation. Thus, the preset time duration for continuously maintaining the target fuel pressure of the low pressure fuel pump at cranking is determined by temperature of a coolant and a soaking time as listed in Table 3 (S43).

TABLE 3

| | Temperature of coolant (° C.) | | | | | | | | |
|---|---|---|---|---|---|---|---|---|---|
| Soaking (Min) | −32 | −30 | −20 | −10 | 20 | 60 | 80 | 100 | 120 |
| 0 | 30 | 30 | 20 | 15 | 10 | 10 | 10 | 20 | 30 |
| 10 | 30 | 30 | 20 | 15 | 10 | 10 | 10 | 20 | 30 |
| 20 | 30 | 30 | 20 | 15 | 10 | 10 | 10 | 20 | 30 |
| 30 | 30 | 30 | 20 | 15 | 10 | 10 | 10 | 20 | 30 |
| 120 | 30 | 30 | 10 | 5 | 5 | 5 | 5 | 10 | 30 |

Referring to FIG. 5, in various embodiments of the present application, the low pressure fuel pump is continuously driven by a relatively higher pressure than the fuel efficiency pressure concentrated on the fuel efficiency within the fuel pressure range that the low pressure fuel pump makes (S52) before a main relay of the vehicle is turned off (S53) at KEY OFF of the vehicle (S51).

That is, when the engine is started again at soaking where the engine is stopped by the KEY OFF and is cooling, it is difficult to restart the engine due to vapor lock where bubbles are generated on the fuel feeding line peculiar to the GDI engine or the engine may be stopped soon after the engine is started again. In order to prevent this phenomenon, the target fuel pressure needs to be strategically controlled from the KEY OFF during the soaking. Eventually, at the KEY OFF, the low pressure fuel pump is driven under the high pressure before the main relay is interrupted.

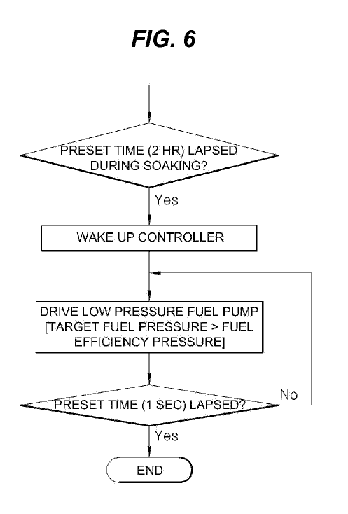

Referring to FIG. 6, in order to prevent the vapor lock phenomenon, the low pressure fuel pump is driven in a preset time interval for a preset duration at the soaking when the engine is cooling after the KEY OFF.

Here, the target fuel pressure of the low pressure fuel pump at the driving of the low pressure fuel pump may be set to a relatively higher pressure, for example, the highest pressure than the fuel efficiency pressure concentrated on the fuel efficiency within the fuel pressure range that the low pressure fuel pump may make.

The preset time interval may be set to every two hours and the preset duration may be set to one second.

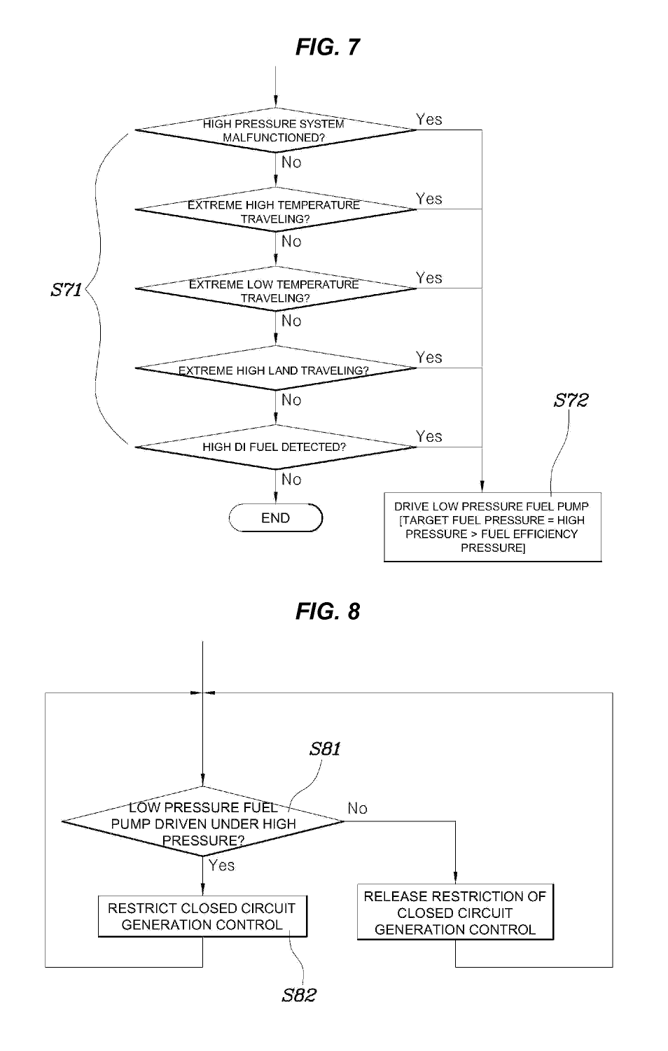

Referring to FIG. 7, in a high pressure condition (S71) including at least a case of malfunction of the high pressure system, an extreme high temperature traveling, an extreme low temperature traveling, an extreme high land traveling, and a HIGH DI fuel detection, the low pressure fuel pump is driven under the high pressure within the fuel pressure range formed by the low pressure fuel pump (S72).

In other words, when the high pressure system is malfunctioned as described above, a high pressure pump of the high pressure system serves as a valve so that the fuel pressure at the low pressure side similar to a usual fuel efficiency pressure cannot maintain the started engine rather the engine may be stopped. In order to prevent this, when malfunction of the high pressure system is detected, the low pressure fuel pump is driven under high pressure to prevent the engine from being stopped.

In addition, in a case when a vehicle travels at extreme high temperatures, at extreme low temperatures, on an extreme high land, or when a HIGH DI (direct injection) fuel indicating a degree of evaporation of fuel is detected, the fuel efficiency pressure concentrated on the fuel efficiency is abandoned and the low pressure fuel pump is driven under high pressure to secure stability in vehicle traveling for maintaining a stable operation of the engine.

Meanwhile, in some cases of the high pressure condition, for example, traveling at the extreme temperatures, at the extreme low temperatures, on the extreme high land, or at detection of the HIGH DI fuel, the low pressure fuel pump may be released when a corresponding situation is completed even during the corresponding traveling cycle is performed. In other cases of the high pressure condition, for example, malfunction of the high pressure system, the high pressure driving of the low pressure fuel pump may be continuously driven under the high pressure within the corresponding traveling cycle.

In other words, since situations may be possibly changed into normal as the vehicle travels in a case of the high pressure condition that includes traveling at the extreme temperature, at the extreme low temperature, on the extreme high land, or at detection of the HIGH DI fuel, the low pressure fuel pump may be released. However, in the case of the malfunction of the high pressure system, since it is almost impossible to recover the normal traveling situation of the vehicle, the low pressure fuel pump should be driven under the high pressure to maintain the ignited state of the engine stable.

Referring to FIG. 8, in various embodiments, the low pressure fuel pump is driven under high pressure within the fuel pressure range that is made by the low pressure fuel pump (S81), a closed circuit generating control for the purpose of improvement of fuel efficiency is restricted (S82) to secure sufficient voltage of a battery.

That is, if an alternator is driven by a closed circuit variable control according to traveling conditions of a vehicle for the improvement of fuel efficiency, since a voltage of a battery consumed during the driving of the low pressure fuel pump by high pressure may be short, the closed circuit generation control is restricted temporally in the situation where the low pressure fuel pump is driven under high pressure so that a stable sufficient voltage of the battery may be guaranteed.

Summing up the cases as illustrated in FIGS. 3 to 7, the low pressure fuel pump is driven by a relatively higher pressure than the fuel efficiency pressure concentrated on the fuel efficiency within the fuel pressure range that is made by the low pressure fuel pump at KEY ON of a vehicle when an engine is stopped, at cranking of the engine, until the main relay is turned off at KEY OFF of the vehicle, and for the preset time duration in the preset time interval at soaking when the engine is cooling after the KEY OFF of the vehicle, while the low pressure fuel pump is driven by high pressure within the fuel pressure range that is made by the low pressure fuel pump even at the malfunction of the high pressure system, the extreme high temperature traveling, the extreme low temperature traveling, at the extreme high land traveling, or detection of the HIGH DI fuel, one or combination of the control methods may be carried out to the vehicle.

When the combination of all of the control methods is applied to a vehicle on which a GDI engine is mounted, a control method of restricting a closed circuit generation control for the purpose of improvement of fuel efficiency to guarantee a sufficient voltage of a battery may be carried out together while the low pressure fuel pump is driven under high pressure within the fuel pressure range that is made by the low pressure fuel pump.

For reference, in a normal operating situation other than the cases as illustrated in FIGS. 3 to 7 (for example, ‘RUN’ in FIG. 2), the target fuel pressure of the low pressure fuel pump is set to the fuel pressure set by concentrating to the fuel efficiency.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of variable-controlling a low pressure fuel pump of a low pressure system in a fuel feeding system of a gasoline direct injection (GDI) engine, the method comprising:
driving the low pressure fuel pump at KEY ON of a vehicle when the GDI engine is stopped; and
setting a target fuel pressure of the low pressure fuel pump to a relatively higher pressure than a fuel pressure concentrated on fuel efficiency within a fuel pressure range that is made by the low pressure fuel pump.

2. The method of claim 1, wherein the target fuel pressure of the low pressure fuel pump is set according to a temperature of a coolant of the GDI engine at the KEY ON.

3. The method of claim 1, wherein the target fuel pressure of the low pressure fuel pump at cranking of the GDI engine is set to a relatively higher pressure than a fuel pressure concentrated on fuel efficiency within a fuel pressure range that is made by the low pressure fuel pump.

4. The method of claim 3, wherein the target fuel pressure of the low pressure fuel pump at the cranking is maintained for a preset time duration determined by temperature of a coolant and a soaking time.

5. A method of variable-controlling a low pressure fuel pump of a low pressure system in a fuel feeding system of a GDI engine, the method comprising:
driving the low pressure fuel pump for a preset time duration in a preset time interval at soaking when the GDI engine is cooling after KEY OFF of a vehicle.

6. The method of claim 5, wherein the low pressure fuel pump is driven continuously under a relatively higher pressure than a fuel efficiency pressure concentrated on fuel efficiency within a fuel pressure range that is made by the low pressure fuel pump, until a main relay is turned off at KEY OFF of a vehicle.

7. The method of claim 5, wherein the low pressure fuel pump is driven at a relatively higher pressure than a fuel efficiency pressure concentrated on fuel efficiency within a fuel pressure range that is made by the low pressure fuel pump for a preset time duration in a preset time interval at KEY ON of a vehicle when the GDI engine is stopped, at cranking of the GID engine, until a main relay is turned off at KEY OFF of a vehicle, and at soaking when the GDI engine is cooling after KEY OFF of the vehicle.

8. The method of claim 7, wherein the low pressure fuel pump is driven within the fuel pressure range that is made by the low pressure fuel pump even at malfunction of a high pressure system, an extreme high temperature traveling, an extreme low temperature traveling, an extreme high land traveling, or at detection of HIGH DI fuel.

9. The method of claim 8, wherein a closed circuit generation control for improving a fuel efficiency is restricted to guarantee a sufficient voltage of a batter during the driving of the low pressure fuel pump under the high pressure within the fuel pressure range that is made by the low pressure fuel pump.

10. The method of claim 5, wherein the target fuel pressure of the low pressure fuel pump at the driving the low pressure fuel pump is set to a relatively higher pressure than a fuel efficiency pressure concentrated on fuel efficiency within a fuel pressure range that is made by the low pressure fuel pump.

11. A method of variable-controlling a low pressure fuel pump of a low pressure system in a fuel feeding system of a GDI engine, the method comprising:
driving the low pressure fuel pump at a high pressure within a fuel pressure range that is made by the low pressure fuel pump in a case when at least one of situations occur, wherein the situations include malfunction of a high pressure system, an extreme high temperature traveling, an extreme low temperature traveling, an extreme high land traveling, or detection of HIGH DI (direct injection) fuel.

12. The method of claim 11, further comprising:
releasing the driving of the low pressure fuel pump at the high pressure when a corresponding situation is completed even during performance of a corresponding traveling cycle in the case of the extreme high temperature traveling, the extreme low temperature traveling, the extreme high land traveling, or the detection of HIGH DI fuel; and
driving the low pressure fuel pump continuously within the corresponding traveling cycle in the case of the malfunction of the high pressure system.

13. A method of variable-controlling a low pressure fuel pump of a low pressure system in a fuel feeding system of a GDI engine, the method comprising:
driving the low pressure fuel pump under a high pressure within a fuel pressure range that is made by the low pressure fuel pump; and
restricting a closed circuit generation control for improving a fuel efficiency to secure a sufficient voltage of a battery during the driving of the low pressure fuel pump under the high pressure.

14. The method of claim 1, wherein the relatively higher pressure within the fuel pressure range that is made by the low pressure fuel pump ranges from about 4 bar to about 6 bar.

15. The method of claim 2, wherein the relatively higher pressure within the fuel pressure range that is made by the low pressure fuel pump ranges from about 4 bar to about 6 bar.

16. The method of claim 3, wherein the relatively higher pressure within the fuel pressure range that is made by the low pressure fuel pump ranges from about 4 bar to about 6 bar.

17. The method of claim 10, wherein the relatively higher pressure within the fuel pressure range that is made by the low pressure fuel pump ranges from about 4 bar to about 6 bar.

18. The method of claim 11, wherein the relatively higher pressure within the fuel pressure range that is made by the low pressure fuel pump ranges from about 4 bar to about 6 bar.

19. The method of claim 12, wherein the relatively higher pressure within the fuel pressure range that is made by the low pressure fuel pump ranges from about 4 bar to about 6 bar.

20. The method of claim 13, wherein the relatively higher pressure within the fuel pressure range that is made by the low pressure fuel pump ranges from about 4 bar to about 6 bar.
